(19) United States
(12) Patent Application Publication
(10) Pub. No.: US 2011/0043538 A1
(43) Pub. Date: Feb. 24, 2011

(54) Method and Arrangement for Zooming on a Display

(75) Inventors: Anders Ericson, Lund (SE); Andreas Agvard, Lomma (SE)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/542,906

(22) Filed: Aug. 18, 2009

(51) Int. Cl. G09G 5/00; G06F 3/041

(52) U.S. Cl. 345/660; 345/173

(57) ABSTRACT

The present invention relates to an improved method for enlarging or reducing scale of a displayed digital content within a display, said display having a touch sensitive portion reactive to a pointing means, the method including identifying a time specific touch on a point with said pointing means. It is determined that the identified time specific touch corresponds to an enlarging operation or a reducing operation of said displayed portion of said digital content within said display screen. The enlarging operation or the reducing operation are performed.

### TECHNICAL FIELD

The present invention relates to zooming in and/or out of a portion of a content of a display of a digital device.

### BACKGROUND

Hand held devices, such as mobile phones, digital cameras, and pocket computers with graphical user interfaces have become increasingly popular in recent years. The most common example of a pocket computer is a smart phone, which may be embodied in various different forms.

Commonly, hand held devices are also provided with cameras for recording and viewing images.

The graphical display is typically touch-sensitive and may be operated by way of a pointing tool such as a stylus, pen or a user's finger. Other devices rely more on a touch-sensitive display as the main input device and have thus dispensed with a hardware keyboard.

The hand held device may be used as a mobile terminal, i.e. in addition to providing typical pocket computer services such as calendar, word processing and games, the hand held device may also be used in conjunction with a mobile telecommunications system for services like voice calls, fax transmissions, electronic messaging, Internet browsing, etc.

It is well known in the field that because of the noticeably limited resources of pocket computers, in terms of physical size, display size, data processing power and input device, compared to laptop or desktop computers, user interface solutions known from laptop or desktop computers are generally not applicable or relevant for pocket computers. One example is enlarging or zooming parts of a content using a pointing device by choosing an area.

It is generally desired to provide improvements to the user interface of such pocket computers so as to enhance the user friendliness and improve the user's efficiency when using the pocket computer. In computers in general, and in pocket computers in particular, there is a need to navigate through content which is larger than what can be displayed on the current display. This is especially apparent when using a web browser application on a pocket computer, as web pages are usually designed to be displayed on normal computer displays being considerably larger than the displays of pocket computers.

In summary, a problem with the prior art in this respect is how to efficiently and intuitively zoom a portion of a displayed content on a hand-held device such as a pocket computer or a mobile communication device, in a simple but efficient manner without use of advanced hardware and complex software.

### SUMMARY

Consequently, there is a need for an invention allowing a user to conveniently and safely zoom in (enlarge) and zoom out (reduce size) of at least a portion of a display content.

For these reasons a method is provided for enlarging or reducing scale of a displayed digital content within a display of a device, said display having a touch sensitive portion reactive to a pointing means. The method includes identifying a time specific touch on a point with said pointing means, determining that the identified time specific touch corresponds to an enlarging operation or a reducing operation of said displayed portion of said digital content within said display screen, and performing the enlarging operation or the reducing operation.

The invention also relates to a device that includes a touch sensitive digital display configured to receive a touch input and a controller. The controller is configured to receive a signal from said display and, when it is determined that a received touch input corresponds to a scale altering touch, alter a scale of a content on said display. The device may further comprise a transceiver mechanism enabling the device to communicate with other devices or systems. The device of may be incorporated in one of a mobile terminal or telephone, a digital media player, a camera, a personal digital assistant, or a computer.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems described herein may be implemented;

FIGS. 2 and 3 illustrate a schematic display according to the invention, and

FIG. 4 is a flow diagram illustrating exemplary processing by the system of FIG. 1.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

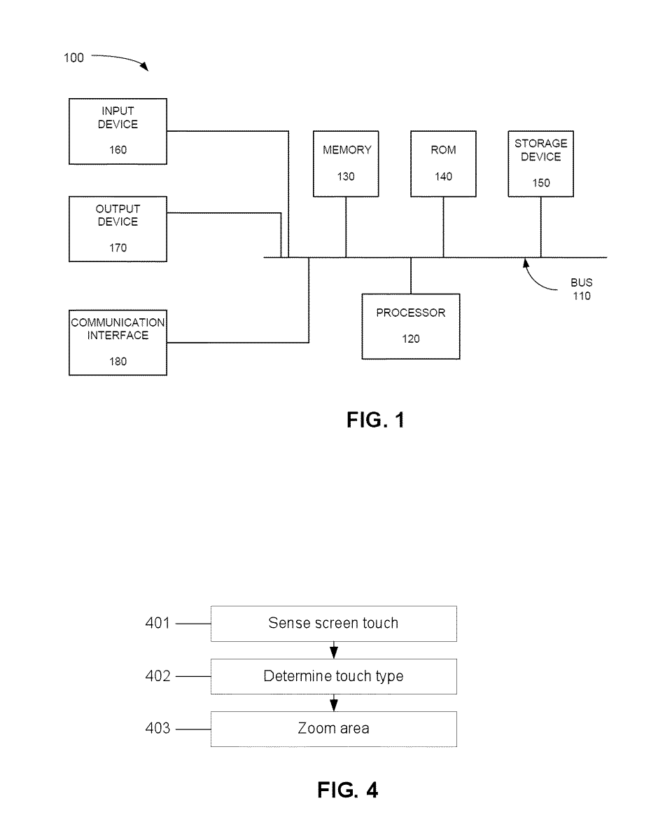

FIG. 1 is a diagram of an exemplary system 100 in which methods and systems described herein may be implemented. System 100 may include a bus 110, a processor 120, a memory 130, a read only memory (ROM) 140, a storage device 150, an input device 160, an output device 170, and a communication interface 180. Bus 110 permits communication among the components of system 100. System 100 may also include one or more power supplies (not shown). One skilled in the art would recognize that system 100 may be configured in a number of other ways and may include other or different elements.

Processor 120 may include any type of processor or microprocessor that interprets and executes instructions. Processor 120 may also include logic that is able to decode media files, such as audio files, video files, multimedia files, image files, video games, etc., and generate output to, for example, a speaker, a display, etc. Memory 130 may include a random access memory (RAM) or another dynamic storage device that stores information and instructions for execution by processor 120. Memory 130 may also be used to store temporary variables or other intermediate information during execution of instructions by processor 120.

ROM 140 may include a conventional ROM device and/or another static storage device that stores static information and instructions for processor 120. Storage device 150 may include a magnetic disk or optical disk and its corresponding drive and/or some other type of magnetic or optical recording medium and its corresponding drive for storing information and instructions. Storage device 150 may also include a flash memory (e.g., an electrically erasable programmable read only memory (EEPROM)) device for storing information and instructions.

Input device 160 may include one or more conventional mechanisms that permit a user to input information to system 100, such as a keyboard, a keypad, a directional pad, a mouse, a pen, voice recognition, a touch screen and/or biometric mechanisms, etc. Output device 170 may include one or more conventional mechanisms that output information to the user, including a display, a printer, one or more speakers, etc. Communication interface 180 may include any transceiver-like mechanism that enables system 100 to communicate with other devices and/or systems. For example, communication interface 180 may include a modem or an Ethernet interface to a LAN. Alternatively, or additionally, communication interface 180 may include other mechanisms for communicating via a network, such as a wireless network. For example, communication interface may include a radio frequency (RF) transmitter and receiver and one or more antennas for transmitting and receiving RF data.

System 100, consistent with the invention, provides a platform through which a user may play and/or view various media, such as music files, video files, image files, games, multimedia files, etc. System 100 may also display information associated with the media played and/or viewed by a user of system 100 in a graphical format, as described in detail below. According to an exemplary implementation, system 100 may perform various processes in response to processor 120 executing sequences of instructions contained in memory 130. Such instructions may be read into memory 130 from another computer-readable medium, such as storage device 150, or from a separate device via communication interface 180. It should be understood that a computer-readable medium may include one or more memory devices or carrier waves. Execution of the sequences of instructions contained in memory 130 causes processor 120 to perform the acts that will be described hereafter. In alternative embodiments, hard-wired circuitry may be used in place of or in combination with software instructions to implement aspects consistent with the invention. Thus, the invention is not limited to any specific combination of hardware circuitry and software.

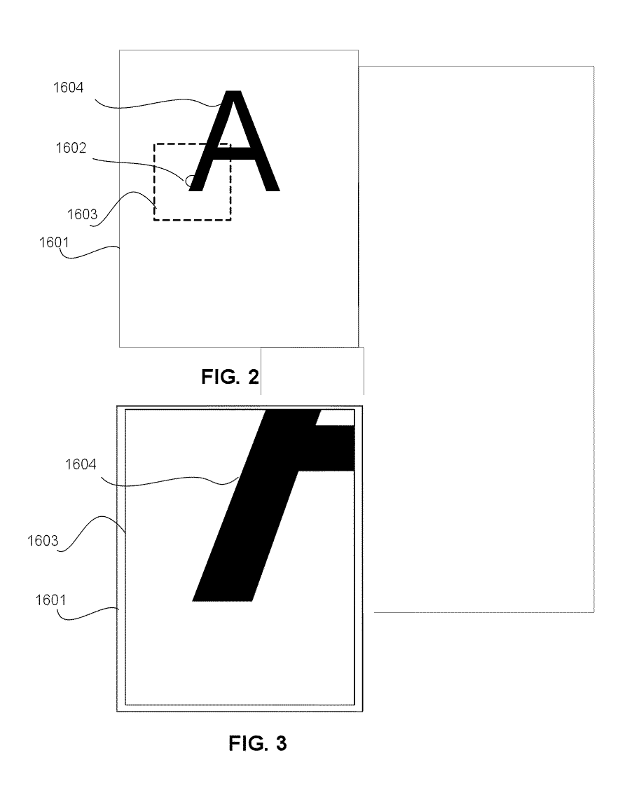

FIG. 2 illustrates a touch screen 1601 of the system 100 as an input device. The touch screen may be a conventional type well known to a skilled person.

A basic touch screen may have three main components: a touch sensor, a controller, and a software driver. A touch screen sensor may have a touch responsive surface. There are several different touch sensor technologies on the market today, each using a different method to detect touch input. Commonly, the sensor generally has an electrical current or signal going through it and touching the screen causes a voltage or signal change. This voltage change is used to determine the location of the touch to the screen. A controller obtains information from the touch sensor and translates it into information that, e.g. processor 120, can understand. In one embodiment the controller and the processor 120 may be integrated.

The tap is interpreted as a zooming (in/out) function. The interpretation may of course be application dependent such that the processor uses this function for zooming in one application, e.g. displaying an image, and as another function in another application.

The terms “tap” and “tapping” used in this application implies touching a portion of the screen in a specific amount of time and/or pressure, predetermined, e.g. in the controller program. The tapping may be just touching the screen and lifting the finger or stylus (or any other device) immediately or keep touching the same portion of the screen for a particular period of time, such as, for example, 0.5 seconds, etc.

The terms “zooming in” and “zooming out” as used in this application implies increasing scale and decreasing scale of an image/content displayed on the display.

The application may be pre-programmed to use a boundary for the zooming, i.e. zooming area 1603, illustrated in FIG. 2 with a dashed line. Substantially, all the content in the zooming area is enlarged or reduced. The zooming area may be predetermined to one or several of shapes, such as a rectangle, circle, ellipse, etc. Normally, the boundary is not visible for the user. However, in one embodiment the zooming area may be visible for a user and allow altering the zooming area size.

When the tapping signal is received and the processor determines that the application running on the system is related to the tapping function, a zooming process starts, which enlarges a portion of the display content 1604. This is illustrated in FIG. 3, in which the zooming area 1603 is enlarged to substantially cover the entire display 1601 area.

To reverse the zooming function, the system may be arranged to sense other types of tapping, e.g. double tapping, in which case the system reduces (or enlarges) the zooming area size to original size or an intermediate size, which can be predetermined.

FIG. 4 is a flow diagram illustrating exemplary processing by system 100. Processing may start when the system 100 powers up. Assume that the user of system 100 has a content displayed, such as an image (still or moving). The image data may be stored on, for example, a storage device or memory 150.

In one implementation, assume that system 100 displays a sign as in FIG. 2. In this implementation, processor 120 may identify information associated with the picture. When a user taps on the screen, the controller may sense the touch type (block 401). For example, the controller may compare a timing table stored in the memory of the controller or system, or may send timing information to the processor 120 to look up the touch type, type of the touching may be determined (block 402). If it is determined that a zooming (in/out) tapping is applied, the processor instructs the display driver to recalculate and output image memory content corresponding to the zooming within the zooming area (block 403).

In addition, the graphical representations provided to a user may represent content retrieved locally from system 100. In some implementations, the content may represent content accessed from an external device, such as a server accessible to system 100 via, for example, a network.

Further, while series of acts have been described with respect to FIG. 4, the order of the acts may be varied in other implementations consistent with the invention. Moreover, non-dependent acts may be performed in parallel.

It will also be apparent to one of ordinary skill in the art that aspects of the invention, as described above, may be implemented in any device/system capable of displaying a content using a touch sensitive screen.

For example, in the implementation described above with respect to FIGS. 1-4, aspects of the invention may be implemented in a mobile terminal/telephone, such as a cellular telephone. In addition, aspects of the invention may be implemented in a digital media player, a camera, a personal digital assistant (PDA), a computer or any other device with content displaying and touch screen capability. Aspects of the invention may also be implemented in methods and/or computer program products. Accordingly, the invention may be embodied in hardware and/or in software (including firmware, resident software, micro-code, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A method for enlarging or reducing scale of a displayed digital content within a display of a device, said display having a touch sensitive portion reactive to a pointing means, comprising:
identifying a time specific touch on a point with said pointing means;
determining that the identified time specific touch corresponds to an enlarging operation or a reducing operation of said displayed portion of said digital content within said display screen; and
performing the enlarging operation or the reducing operation.

2. The method of claim 1, wherein the enlarging or reducing operation is limited to a predetermined boundary.

3. The method of claim 2, wherein said predetermined boundary has a centre at said point.

4. The zooming method of claim 1, wherein the enlarging or reducing operation is based to number of touches of said touch sensitive portion.

5. A device, comprising:
a touch sensitive digital display configured to receive a touch input; and
a controller,
wherein said controller is configured to receive a signal from said display and, when it is determined that a received touch input corresponds to a scale altering touch, alter a scale of a content on said display.

6. The device of claim 5, further comprising a transceiver mechanism enabling the device to communicate with other devices or systems.

7. The device of claim 5, being incorporated in one of a mobile terminal or telephone, a digital media player, a camera, a personal digital assistant, or a computer.
